(19) United States
(12) Patent Application Publication
(10) Pub. No.: US 2017/0275133 A1
(43) Pub. Date: Sep. 28, 2017

(54) FLAT CABLE REEL DEVICE

(71) Applicants: Yi Chen CHEN, Taipei City (TW); I-MORE SCIENCE AND TECHNOLOGY COMPANY (SHENZHEN), Taipei City (TW); TOP DEN ELECTRONICS LIMITED (DONG GUAN), Dongguan City (CN)

(72) Inventor: Captain CHEN, Taipei City (TW)

(73) Assignees: Yi Chen CHEN, Taipei City (TW); I-MORE SCIENCE AND TECHNOLOGY COMAPANY (SHENZHEN), Taipei City (TW); TOP DEN ELECTRONICS LIMITED (DONG GUAN), Dongguan City (CN)

(21) Appl. No.: 15/308,782

(22) PCT Filed: Mar. 20, 2015
(86) PCT No.: PCT/CN2015/074732

§ 371 Date: May 30, 2017

(30) Foreign Application Priority Data
May 5, 2014 (CN) 201410186508.5

(51) Int. Cl. B65H 75/34; H02G 11/02; B65H 75/44

(52) U.S. Cl. CPC B65H 75/34; B65H 75/44; H02G 11/02

(57) ABSTRACT

A flat cable reel device includes a housing, a rotary sleeve, an upper spiral spring and a lower spiral spring. The housing is provided with a board outlet. The reel device includes the upper spiral spring, the lower spiral spring, an upper central shaft and a lower central shaft, which form a symmetrical and balanced double-spring structure; when a flexible printed circuit board is reeled or unreeled, the force and the reaction force generated by the springs are evenly distributed over the upper portion and the lower portion of the rotary sleeve, such that the rotary sleeve can balance.

### TECHNICAL FIELD

The present disclosure relates to a reel device, in particular to a flat cable reel device.

### BACKGROUND

Currently, reel device is usually applied to reel the wires of corded earphone, mouse, keyboard, charger and the like. Such as China Patent No. 200620116285.6 disclosing a wire reel device with single free end, and China Patent No. 200620116284.1 disclosing a wire reel device with double free end. The basic principle is that the wire can be reeled along a spiral path or ring path via the elasticity of the spiral spring; when the wire is unreeled, the movement of pulling out the wire is slightly restricted due to the restriction force from the spiral spring, but the restriction force can be easily overcome. Thus, when the user can reel or unreel the wire along a certain path, and the power applied by the user can be slighting restricted, so the user can smoothly reel or unreel the wire.

In recent years, some manufacturers apply reel device to reel or unreel flat cable; for example, flexible printed circuit board (FPC board). However, the difference is that they use the device to reel or unreel wider and flat flexible printed circuit board, such as server; one end of a flexible printed circuit board connects to the mainboard of a server, and the other end thereof connects to the hard disk or circuit board of the server is a draw-out structure. When one end of the hard disk or circuit board of the server is pulled out, the reel device unreels the flexible printed circuit board; when one end of the hard disk or circuit board of the server is pushed in, the reel device automatically reels the flexible printed circuit board. Therefore, when the flexible printed circuit board is reeled or unreeled in the limited space of the housing of the server, the reel device can pull out the flexible printed circuit board by a certain length according to the requirement, and the flexible printed circuit board can have a certain tension and balance force, such that the long flexible printed circuit board can keep a safe distance with a lot of high-temperature electronic components in the narrow space.

The conventional flat cable reel device is as shown in FIG. 1˜FIG. 2, and its major components include an upper housing 101, a lower housing 102, a rotary sleeve 103, a spiral spring 104 and a sleeve cover 105. The upper housing 101 is provided with 4 upper plastic columns downward and integrally formed with the four corners thereof; the lower housing 102 is provided with 4 upper plastic columns upward and integrally formed with the four corners thereof; the bottom of each of the upper plastic columns 101_1 is provided with a protrusion edge, and the top of each of the lower plastic columns 102_1 is provided with a ring stage corresponding to the protrusion edge; the upper housing 101 is combined with the lower housing 102 to form a housing. The lower housing 102 is provided with a central shaft 106 upward and integrally formed with the center thereof, and the top of the central shaft 106 is provided with a clamping groove. The rotary sleeve 103 is provided with the axial hole corresponding to the central shaft 106, and the top of the rotary sleeve 103 is provided with an accommodating space 103_1 for accommodating the spiral spring 104, and the outer surface of the rotary sleeve 103 is further provided with a protection sheet 107; a buckle area is formed between the protection sheet 107 and the rotary sleeve 103, and the buckle area is slightly larger than the thickness of one layer of the flexible printed circuit board 108. The assembly process is: first, put the flexible printed circuit board into the buckle area of the rotary sleeve 103; then, put the spiral spring 104 into the accommodating space 103_1 of the rotary sleeve 103, and then the inner center of the spiral spring 104 is caught at the clamping groove of the central shaft 106, and the outer end of the spiral spring 104 is caught at the rotary sleeve 103; afterward, align the axial hole of the rotary sleeve 103 with the central shaft 106 of the lower housing 102, and then insert the rotary sleeve 103 into the central shaft 106; then, insert the protrusion edge at the bottom of the upper plastic column 101_1 of the upper housing 101 into the ring stage at the top of the lower plastic column 102_1 of the lower housing 102 to combine the upper housing 101 and the lower housing 102, such that four upper plastic columns 101_1 and four lower plastic column 102_1 form the two plastic columns at the left side and two plastic columns at the right side; further, one end of the flexible printed circuit board 108 passes through the space between the two plastic columns at the left side, and the other end thereof passes through the space between the two plastic columns at the right side; finally, fasten up the upper housing 101 and the lower housing 102 by screws. The stretching operation principle is: during the initial status, the flexible printed circuit board 108 is reeled around the rotary sleeve 103; when it is necessary to pull out the flexible printed circuit board 108, the user can pull one end or both ends of the flexible printed circuit board 108 to stretch the flexible printed circuit board 108 and make the flexible printed circuit board 108 being the stretching status; at this time, if the user release the flexible printed circuit board 108 or let it freely move with the rotary sleeve 103, the rotary sleeve 103 rotates by the spring force provided by the spiral spring 104, so the flexible printed circuit board 108 can be reeled by the rotary sleeve 103 to return to the initial status in this way, the flexible printed circuit board 108 can be automatically reeled.

The shortcoming of the conventional flat cable reel device is: (1) the housing only has one spiral spring 104, and the spiral spring 104 is at the top of the rotary sleeve 103; when the flexible printed circuit board 108 is reeled or unreeled, the force and the reaction force generated by the spiral spring 104 becoming tight or loose will concentrate on the upper portion of the rotary sleeve 103, such that the rotary sleeve 103 cannot be balanced, which make the rotary sleeve 103 cannot rotate smoothly or even get damaged; (2) the central shaft 106 penetrates through the whole rotary sleeve 103, so the length of the central shaft 106 (which should he greater or equal to the length of the flexible circuit board 108, greater than 60 mm) should be longer; thus, the central shaft 106 tends to break due to the centrifugal force caused by the rotation of the rotary sleeve 103 after the reel device has been used for a long time.

### SUMMARY

Therefore, it is a primary objective of the present invention to provide a flat cable reel device not tending to be damaged and the rotary sleeve thereof can rotate smoothly.

The present invention is realized by the following technical measures: a flat cable reel device, which includes a housing, a rotary sleeve, an upper spiral spring and a lower spiral spring. The housing is provided with a board outlet. The upper portion of the rotary sleeve is provided with an upper accommodating space and the lower portion of the rotary sleeve is provided with a lower accommodating space, and the upper spiral spring is disposed in the upper accommodating space and the lower spiral spring is disposed at the lower accommodating space. The upper portion of the housing is provided with an upper central shaft and the lower portion of the housing is provided with a lower central shaft. The upper central shaft extends into the upper accommodating space of the rotary sleeve and catches the upper spiral spring and the lower central shaft extends into the lower accommodating space of the rotary sleeve and catches the lower spiral spring, whereby the rotary sleeve is rotatably disposed in the housing, and the outer surface of the rotary sleeve is provided with a protection sheet for catching the flexible printed circuit board.

The technical effects of the present invention are: the present invention provides the upper spiral spring, the lower spiral spring, an upper central shaft and a lower central shaft, which form a symmetrical and balanced double-spring structure; when a flexible printed circuit board is reeled or unreeled, the force and the reaction force generated by the springs are evenly distributed over the upper portion and the lower portion of the rotary sleeve, such that the rotary sleeve can balanced, which make the rotary sleeve can rotate smoothly and will not be easily damaged; besides, the central shaft is divided in to the upper central shaft and the lower central shaft, which can effectively reduce the length, so the central shaft does not tend to break.

### BRIEF DESCRIPTION OF THE DRAWINGS

FIG. 1 is an exploded view of a conventional flat cable reel device.

FIG. 2 is structural schematic view of the conventional flat cable reel device without spiral spring and flexible printed circuit board.

FIG. 3 is an exploded view of a first embodiment in accordance with the present invention.

FIG. 4 is a structural schematic view of the upper housing, the lower housing, the upper central shaft and the lower central shaft of the first embodiment in accordance with the present invention.

FIG. 5 is a top view of FIG. 4.

FIG. 6 is a top view of lower housing of the first embodiment in accordance with the present invention.

FIG. 7 is a structural schematic view of the rotary sleeve, the protection sheet and the lower rotary sleeve cover of the first embodiment in accordance with the present invention.

FIG. 8 is an exploded view of FIG. 7.

FIG. 9 is a top view of FIG. 7.

FIG. 10 is an A-A sectional view of FIG. 9.

FIG. 11 is a structural schematic view of the upper rotary sleeve cover of the first embodiment in accordance with the present invention.

FIG. 12 is an exploded view of a second embodiment in accordance with the present invention.

FIG. 13 is a structural schematic view of the second embodiment in accordance with the present invention without the flexible printed circuit board, the upper spiral spring, the lower spiral spring, the upper positioning column and the lower positioning column.

FIG. 14 is a structural schematic view of FIG. 13 without the right housing.

FIG. 15 is a structural schematic view of another view angle of FIG. 14.

FIG. 16 is a structural schematic view of right housing of the second embodiment in accordance with the present invention.

FIG. 17 is a structural schematic view of the rotary sleeve, the protection sheet and the lower rotary sleeve cover of the second embodiment in accordance with the present invention.

FIG. 18 is an exploded view of FIG. 17.

FIG. 19 is a top view of FIG. 17.

FIG. 20 is an A-A sectional view of FIG. 19.

FIG. 21 is a structural schematic view of the upper outer rotary axial plate of the second embodiment in accordance with the present invention.

FIG. 22 is a structural schematic view of another view angle of FIG. 21.

FIG. 23 is a structural schematic view of the upper rotary sleeve cover of the second embodiment in accordance with the present invention.

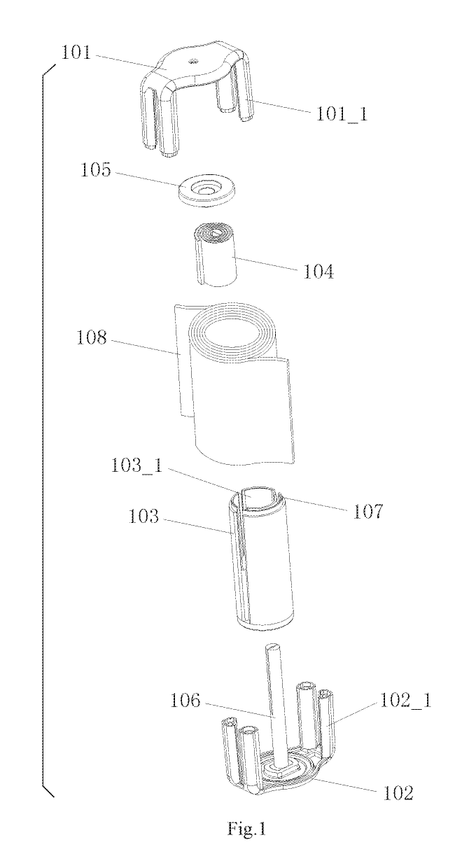

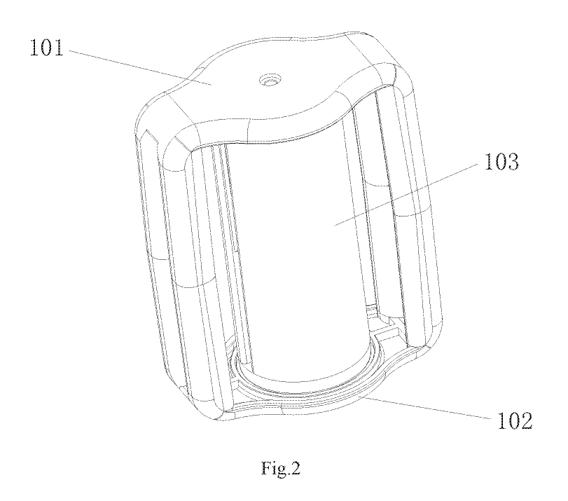

FIG. 1 and FIG. 2 of the present disclosure wherein:

101—upper housing, 101_1—upper plastic column, 102—lower housing, 102_1—lower plastic column, 103—rotary sleeve, 103_1—accommodating space, 104—spiral spring, 105—rotary sleeve cover, 106—central shaft, 107—protection sheet, 108—flexible printed circuit board;

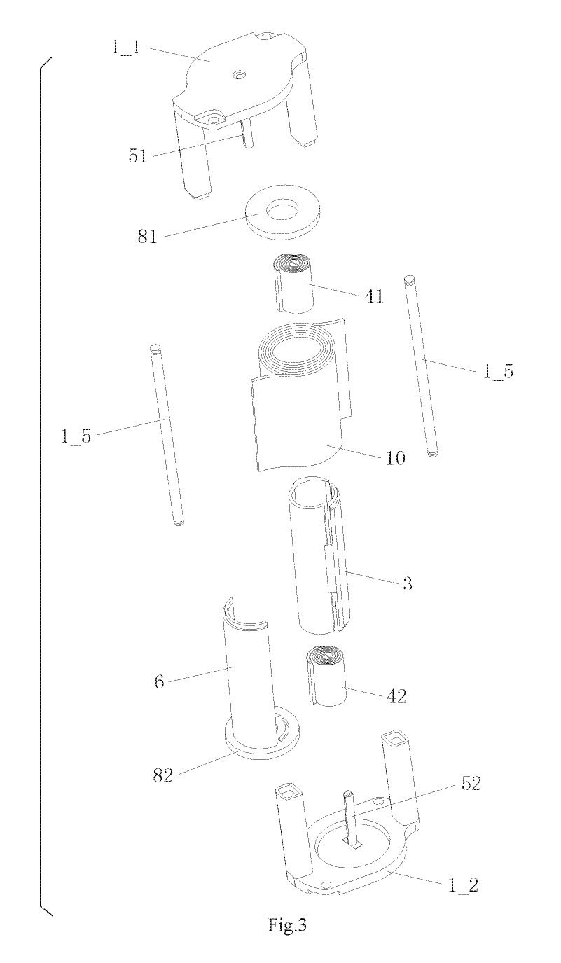

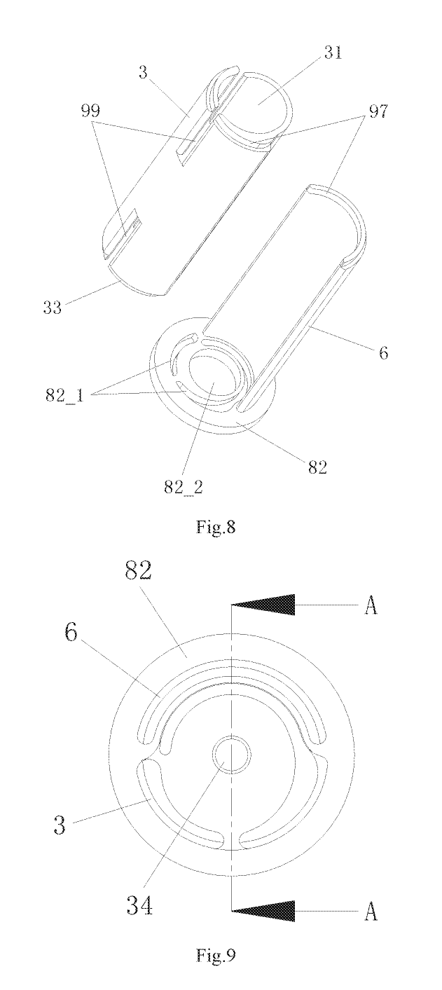

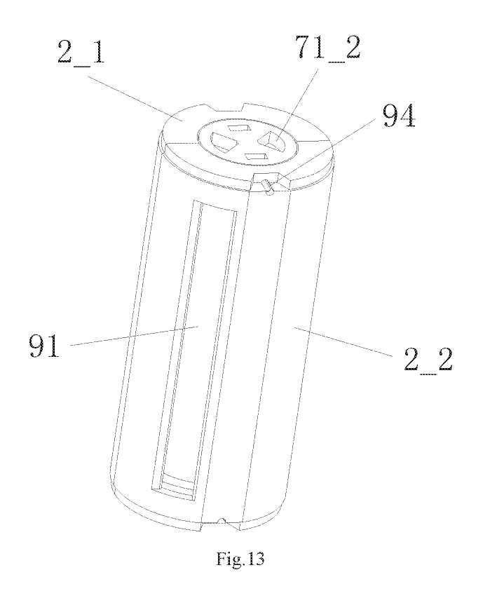

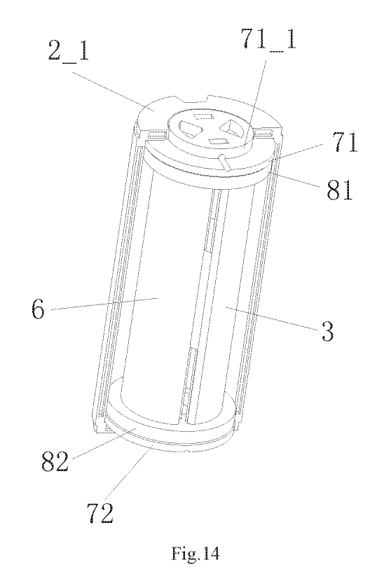

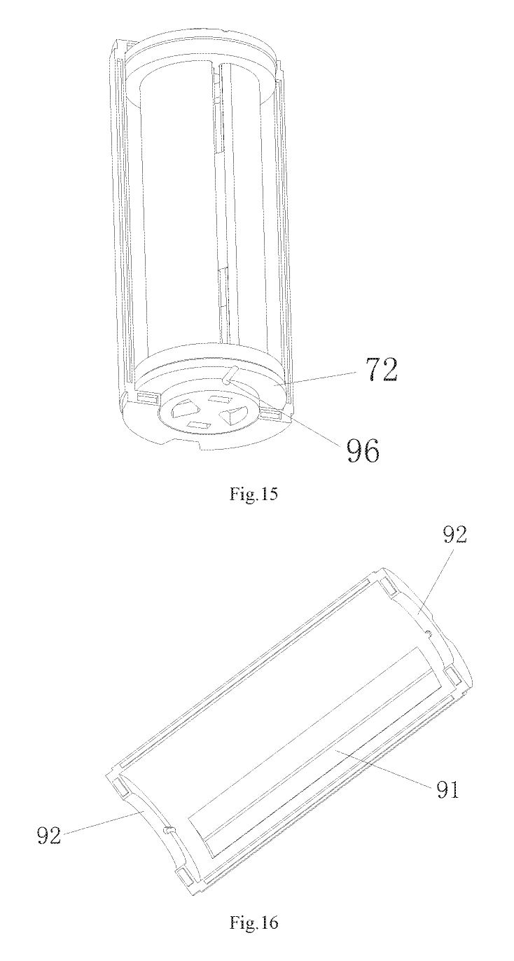

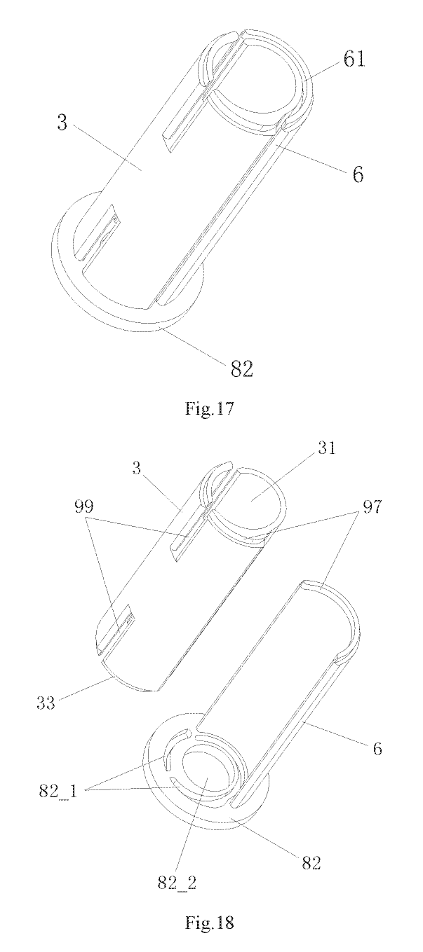

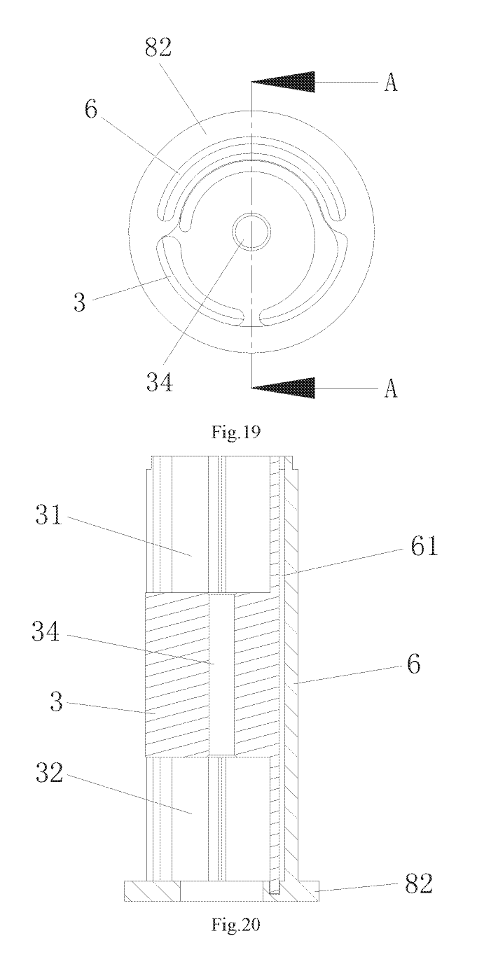

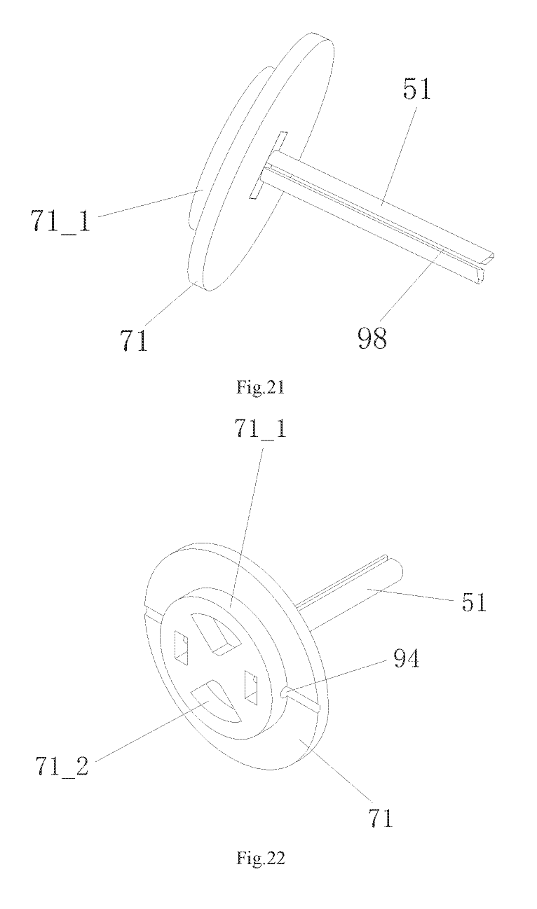

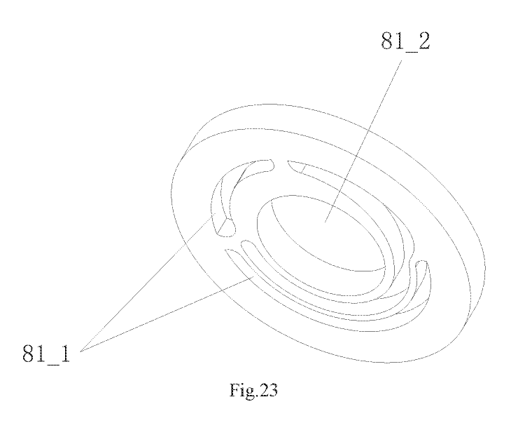

FIG. 3 to FIG. 23 of the present disclosure wherein:

1_1—upper housing, 1_2—lower housing, horizontal central axis, 1_4—direction, 1_5—metal support column, 1_6—plastic support column, 1_7—circular restrict slot, 2_1—left housing, 2_2—right housing, 3—rotary sleeve, 31—upper accommodating space, 32—lower accommodating space, 33—lower protrusion edge, 34—penetration hole, 41—upper spiral spring, 42—lower spiral spring, 51—upper central shaft, 52—lower central shaft, 6—protection sheet, 61—buckle area, 71—upper outer rotary axial plate, 71_1—protrusion, 71_2—fan-shaped slot, 72—lower outer rotary axial plate, 81—upper rotary sleeve cover, 81_1—upper slot, 81_2—upper circular hole, 82—lower rotary sleeve cover, 82_1—lower slot, 82_2—lower circular hole, 91—board outlet, 92—semi-circular slot, 93—upper positioning column, 94—upper positioning hole, 95—lower positioning column, 96—lower positioning hole, 97—upper protrusion edge, 98—clamping groove, 99—clamping space, 10—flexible printed circuit board.

### DETAILED DESCRIPTION

The following is further description of the present invention with drawings.

### First Embodiment

Please refer to FIG. 3˜FIG. 11, which show the flat cable reel device in accordance with the present invention; the flat cable reel device includes a housing, a rotary sleeve 3, an upper spiral spring 41 and a lower spiral spring 42. The housing is provided with a board outlet 91 for the flexible circuit board to be reeled out.

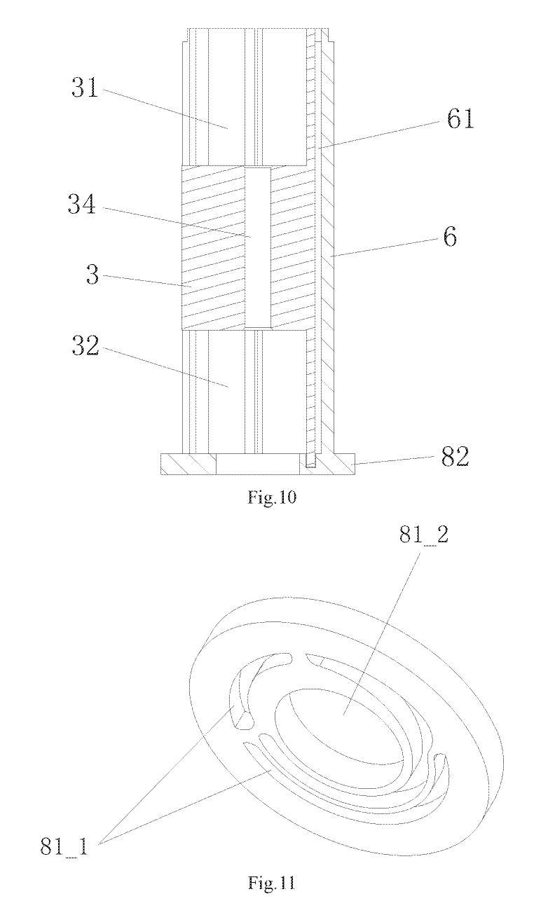

The upper portion of the rotary sleeve 3 of the present invention is provided with an upper accommodating space 31 and the lower portion of the rotary sleeve 3 is provided with a lower accommodating space 32 (as shown in FIG. 10), and the upper spiral spring 41 is disposed in the upper accommodating space 31 of the rotary sleeve 3 and the lower spiral spring 42 is disposed at the lower accommodating space 32 of the rotary sleeve 3. The upper portion of the housing is provided with an upper central shaft 51 and the lower portion of the housing is provided with a lower central shaft 52. The upper central shaft 51 extends into the upper accommodating space 31 of the rotary sleeve 3 and catches the upper spiral spring 41 and the lower central shaft 52 extends into the lower accommodating space 32 of the rotary sleeve 3 and catches the lower spiral spring 42, whereby the rotary sleeve 3 is rotatably disposed in the housing, and the outer surface of the rotary sleeve 3 is provided with a protection sheet 6 for catching the flexible printed circuit board 10. In the above structure, the upper accommodating space 31 is symmetrical to the lower accommodating space 32; the upper spiral spring 41 is symmetrical to the lower spiral spring 42, and the upper central shaft 51 is symmetrical to the lower central shaft 52, which form a balanced double-spring structure. When the flexible printed circuit board 10 is reeled or unreeled, the force and the reaction force generated by the springs (the upper spiral spring 41 and the lower spiral spring 42) are evenly distributed over the upper portion and the lower portion of the rotary sleeve 3, such that the rotary sleeve 3 can balanced, which make the rotary sleeve 3 can rotate smoothly and will not be easily damaged. Besides, the central shaft is divided into the upper central shaft 51 and the lower central shaft 52, which can effectively reduce the length. In other words, the length of the upper central shaft or the length of the lower central shaft is lower than a half of the length of the original central shaft. In this way, in the manufacturing process, the diameter and the strength of the upper central shaft 51 and the lower central shaft 52 can be relatively increased, such that the upper central shaft 51 and the lower central shaft 52 do not tend to break.

In the embodiment, the housing includes an upper housing 1_1 and a lower housing 1_2; the upper housing 1_1 and the lower housing 1_2 are combined with each other to form the housing. The board outlet includes a left board outlet 91 and a right board outlet 91, and the rotary sleeve 3 is rotatably disposed between the upper housing 1_1 and the lower housing 1_2.

There are four support columns arranged to form a rectangle, and connecting the four corners of the upper housing 1_1 to the four corners of the lower housing 1_2. Two support columns in left side forms a left board outlet 91, and two support columns in right side forms a right board outlet 91. The support column in front of the left board outlet 91 and the support column behind the right board outlet 91 contact the flexible circuit board 10 to serve as the force bearing support columns to bear the force generated during the flexible circuit board 10 is unreeled (which is based on the winding direction of the flexible circuit board 10 shown in FIG. 3, inverse to the winding direction shown in FIG. 1).

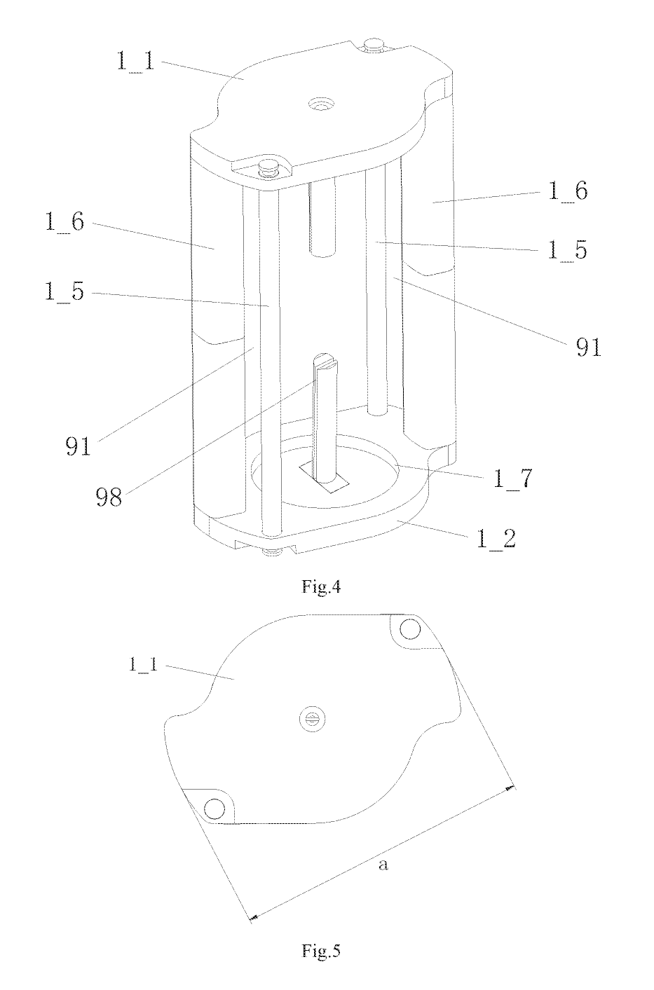

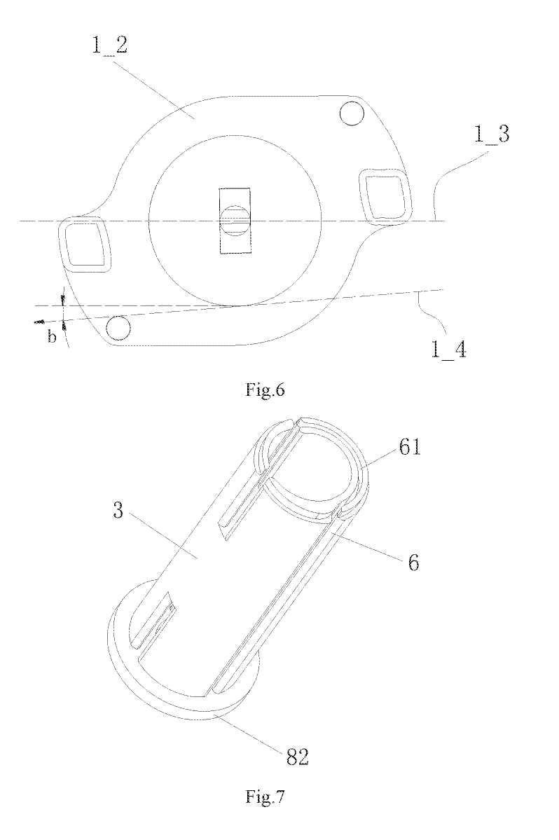

The left board outlet 91 is in the vicinity of the front end of the horizontal central axis 1_3 of the rotary sleeve 3, and the right board outlet 91 is in the vicinity of the rear end of the horizontal central axis 91 of the rotary sleeve 3. In other words, the left board outlet 91 is shifted forward in the direction of the central shaft, and the right board outlet 91 is shifted backward in the direction of the central shaft (compared with the board outlets of the conventional flat cable reel device), such that the upper housing 1_1 and the lower housing 1_2 form a “S”-shaped structure (as shown in FIG. 5). This structure can not only reduce the distance (a) between the left board outlet 91 and the right board outlet 91, which can decrease the whole size of the reel device; moreover, as shown in FIG. 6, the tangent line of the inner side of the force bearing support column and the rotary sleeve 3 is smoother, so the included angle (b) of the outlet direction 1_4 and the horizontal line is reduced; therefore, the frictional force generated during the flexible circuit hoard 10 is reeled or unreeled can be decreased, so the flexible circuit board 10 can be more smoothly reeled or unreeled.

The support column in front of the left hoard outlet 91 and the support column behind the right board outlet 91 are metal support columns, and one end of each of the metal support columns 1_5 is caught on the upper housing 1_1 and the other end thereof is caught on the lower housing 1_2. In other words, each of the metal support columns 1_5 can directly penetrate the upper housing 1_1 and the lower housing 1_2 instead of including two sections connecting to each other; the metal support columns 1_5 can be metal cylinders. Compared with plastic columns, the metal support columns 1_5 are of high strength and great wear-resistivity, which can further reduce the size (or the diameter) of the force bearing support columns, and further decrease the included angle between the outlet direction 1_4 and the horizontal line; for the reason, the force bearing support columns do not tend to break.

Preferably, in the embodiment, the support column behind the left board outlet 91 and the support column in front of the right hoard outlet 91 are plastic support columns 1_6. The plastic support column 1_6 is formed by connecting an upper plastic column and a lower plastic column; the upper plastic column is integrally formed with the upper housing 1_1, and the lower plastic column is integrally formed with the lower housing 1_2. The two force bearing support columns are mental support columns, and the other support columns are plastic support columns, and the plastic support columns are the same with those of the conventional flat cable reel device. In this way, the production and assembly of the device can be more convenient.

Of course, all of the four support columns can also be metal support columns; in other words, the support column behind the left board outlet 91 and the support column in front of the right board outlet 91 are metal support columns; one end of each of the metal support columns is caught on the upper housing 1_1 and the other end thereof is caught on the lower housing 1_2. The above structure is also feasible. Of course, both of the structure with two metal support columns and the structure with four metal support columns are within the protection range of the present invention.

Preferably, the top of the upper central shaft 51 can be integrally formed with or caught on the housing, and the bottom of the lower central shaft 52 can be integrally formed with or caught on the housing. More specifically, in the embodiment, the top of the upper central shaft can be integrally formed with the center of the upper housing 1_1, and the bottom of the lower central shaft 52 can be integrally formed with the center of the lower housing 1_2; for example, the upper central shaft 51 and the upper housing 1_1 can be manufactured by the plastic integrally forming process, and the lower central shaft 52 and the lower housing 1_2 can also be manufactured by the plastic integrally forming process. Of course, the central shaft and the housing can also be divided into two components to be separately manufactured; for example, the top of the upper central shaft 51 is caught on the central of the upper housing 1_1, and the bottom of the lower central shaft 52 is caught on the center of the lower housing 1_2 so as to satisfy the different the material strength requirements of the central shaft and the housing; once the central shafts connect to the inner center of the spiral spring, the central shafts should resist the tension of the spiral spring stretching or retracting; therefore, the outer rotary axial plates can be made of plastics, but the central shafts can be made of metal bar capable of resisting strong tension and with low diameter.

Preferably, the bottom of the protection sheet 6 is integrally formed with a lower rotary sleeve cover 82 circular in shape, and the lower rotary sleeve cover 82 is provided with a lower slot 82_1, and the bottom of the rotary sleeve 3 is provided with a lower protrusion edge 33 corresponding to the lower slot 82_1 of the lower rotary sleeve cover 82. When assembling the device, the user inserts the lower protrusion edge 33 of the rotary sleeve 3 into the lower slot 82_1 of the lower rotary sleeve cover 82 whereby the lower rotary sleeve cover 82 is caught on the bottom of the rotary sleeve 3, and the protection sheet 6 is fixed on the rotary sleeve 3. Further, a buckle area 63 is formed between the protection sheet 6 and the rotary sleeve 3. The lower rotary sleeve cover 82 is further provided with a lower circular hole 82_2 for the lower central shaft 52 to penetrate through. The top of the rotary sleeve 3 is caught and fixed on the upper rotary sleeve cover 81, and the upper rotary sleeve cover 81 is provided with an upper slot 81_1, and the top of the rotary sleeve 3 and the top of the protection sheet 6 are respectively provided with an upper protrusion edge 97 corresponding to the upper slot 81_1 of the upper rotary sleeve cover 81. When assembling the device, the user inserts the upper protrusion edge 97 into the upper slot 81_1 of the upper rotary sleeve cover 81. Moreover, the bottom of the upper housing 1_1 is provided with a circular restrict slot 1_7 corresponding to the upper rotary sleeve cover 81, and the top of the lower housing 1_2 is also provided with a circular restrict slot 1_7 corresponding to the lower rotary sleeve cover 82. The external diameter of the upper rotary sleeve cover 81 and the external diameter of the lower rotary sleeve cover 82 are slightly shorter than the diameter of the circular restrict slots 1_7. The advantages of the above structure are: (1) the rotary sleeve 3 and the protection sheet 6 are two independent components, so the protection sheet 6 can be freely removed to make the assembly operation more convenient; further, which can also avoid the problem that the current plastic injection molding cannot increase the mold removing precision when the mold removing space is too deep and too narrow; thus, the above structure can provide more space for the rotary sleeve 3, and can also make the operation of put the flexible printed circuit board 10 on the outer surface of the rotary sleeve 3 easier; (2) the structure has independent rotary sleeve 3 and protection sheet 6, so the function of the rotary sleeve 3 is only to mount the spiral spring; for the reason, the rotary sleeve 3 can be a simple ring structure; thus, the rotary sleeve 3 can become stronger and will not be deformed or damaged because the spiral spring inside the rotary sleeve 3 stretches or retracts.

Preferably, in the embodiment, the center of the rotary sleeve 3 is provided with a penetration hole 34 circular in shape, and the penetration hole 34 interconnects the center of the upper accommodating space 31 to the center of the lower accommodating space 32, whereby the bottom of the upper central shaft 51 is disposed at the top of the penetration hole 34, and the top of the lower central shaft 52 is disposed at the bottom of the penetration hole 34. In addition, the upper central shaft 51 is provided with a clamping groove 98 for catching the inner center of the upper spiral spring 41, and the upper portion of the rotary sleeve 3 is provided with a clamping space 99 for catching the outer side of the upper spiral spring 41; the lower central shaft 52 is provided with a clamping groove 98 for catching the inner center of the lower spiral spring 42, and the lower portion of the rotary sleeve 3 is provided with a clamping space 99 for catching the outer side of the lower spiral spring 42. Of course, the upper central shaft 51 and the lower central shaft 52 are at the same vertical line to form the rotation shaft of the rotary sleeve 3. In this way, the rotary sleeve 3 can stably rotate around the rotation shaft formed by the upper central shaft 51 and the lower central shaft 52.

The assembly process of the present invention is: first, put the upper spiral spring 41 into the upper accommodating space 31 of the rotary sleeve 3, and put the lower spiral spring 42 into the lower accommodating space 32 of the rotary sleeve 3, and make the outer side of the upper spiral spring 41 be caught on the clamping space 99 at the upper portion of the rotary sleeve 3, and make the outer side of the lower spiral spring 42 be caught on the clamping space at the lower portion of the rotary sleeve 3; then, put the flexible printed circuit board 10 around the outer surface of the rotary sleeve 3, and then fix the protection sheet 6 to make the flexible printed circuit board 10 be fixed in the buckle area 61 between the protection sheet 6 and the outer surface of the rotary sleeve 3; next, catch the upper rotary sleeve cover 81 on the top of the rotary sleeve 3; then, install the upper housing 1_1 and the lower housing 2_1, and then make the inner center of the upper spiral spring 41 be caught on the clamping groove 98 of the upper central shaft 51, and make the inner center of the lower spiral spring 42 be caught on the clamping groove 98 of the lower central shaft 52 to finish the assembly process.

The working principle of the present invention is: during the initial status, the flexible printed circuit board 10 is reeled around the rotary sleeve 3; when it is necessary to pull out the flexible printed circuit board 10, the user can pull one end or both ends of the flexible printed circuit board 10 to stretch the flexible printed circuit board 108 and make the flexible printed circuit board 10 being the stretching status; at this time, if the user release the flexible printed circuit board 10 or let it freely move with the rotary sleeve 10, the rotary sleeve 3 rotates by the spring force provided by the upper spiral spring 41 and the lower spiral spring 42, so the flexible printed circuit board 10 can be reeled by the rotary sleeve 3 to return to the initial status; in this way, the flexible printed circuit board 10 can be automatically reeled.

### Second Embodiment

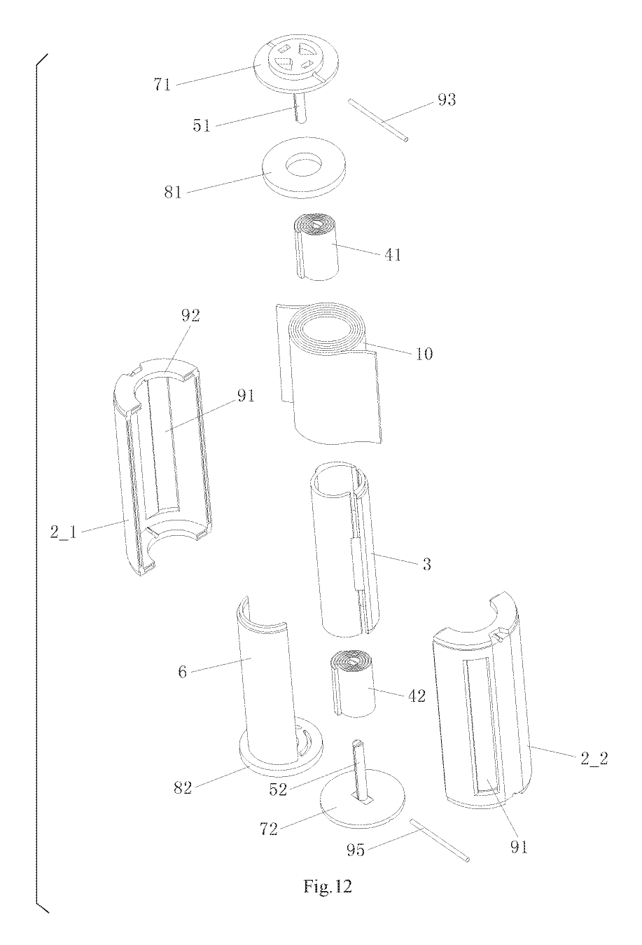

Please refer to FIG. 12-FIG. 23, which show a second embodiment of a flat cable reel device in accordance with the present invention; the flat cable reel device includes a housing, a rotary sleeve 3, an upper spiral spring 41 and a lower spiral spring 42. The housing is provided with a board outlet 91 for the flexible circuit board to be reeled out.

The upper portion of the rotary sleeve 3 of the present invention is provided with an upper accommodating space 31 and the lower portion of the rotary sleeve 3 is provided with a lower accommodating space 32 (as shown in FIG. 20), and the upper spiral spring 41 is disposed in the upper accommodating space 31 of the rotary sleeve 3 and the lower spiral spring 42 is disposed at the lower accommodating space 32 of the rotary sleeve 3. The upper portion of the housing is provided with an upper central shaft 51 and the lower portion of the housing is provided with a lower central shaft 52. The upper central shaft 51 extends into the upper accommodating space 31 of the rotary sleeve 3 and catches the upper spiral spring 41 and the lower central shaft 52 extends into the lower accommodating space 32 of the rotary sleeve 3 and catches the lower spiral spring 42, whereby the rotary sleeve 3 is rotatably disposed in the housing, and the outer surface of the rotary sleeve 3 is provided with a protection sheet 6 for catching the flexible printed circuit board 10. In the above structure, the upper accommodating space 31 is symmetrical to the lower accommodating space 32; the upper spiral spring 41 is symmetrical to the lower spiral spring 42, and the upper central shaft 51 is symmetrical to the lower central shaft 52, which form a balanced double-spring structure. When the flexible printed circuit board 10 is reeled or unreeled, the force and the reaction force generated by the springs (the upper spiral spring 41 and the lower spiral spring 42) are evenly distributed over the upper portion and the lower portion of the rotary sleeve 3, such that the rotary sleeve 3 can balanced, which make the rotary sleeve 3 can rotate smoothly and will not be easily damaged. Furthermore, it can effectively reduce the length to divide the central shaft into the upper central shaft 51 and the lower central shaft 52; in other words, the length of the upper central shaft 51 or the length of the lower central shaft 52 is lower than a half of the length of the original central shaft. In this way, in the manufacturing process, the diameter and the strength of the upper central shaft 51 and the lower central shaft 52 can be relatively increased, such that the upper central shaft 51 and the lower central shaft 52 do not tend to break.

In the embodiment, the housing includes a left hosing 2_1 and a right housing 2_2, and the left housing 2_2 is combined with the right housing 2_2 to form the housing. The board outlet includes a left board outlet 91 and a right board outlet 91; the left board outlet 91 is disposed on the left housing 2_1 and the right board outlet 91 is disposed on the right housing 2_2; one of the board outlet 91 is opposite to the other one. In this way, one end of the flexible printed circuit board 10 can be pulled out from one of the board outlets 91 and the other end thereof can be pulled out from the other one of the board outlets 91. The rotary sleeve 3 is rotatably disposed between the left housing 2_1 and the right housing 2_2.

More specifically, in the embodiment, the right side of the left housing 2_1 is provided with a groove, and the left side of the righting housing 2_2 is provided with a protrusion bar, and the protrusion bar is inserted into the groove to combine the left housing 2_1 and the right housing 2_2. The housing of the present invention is composed of the left housing 2_1 and the right housing 2_2 closely fixed with each other, which can increase the connection area, whereby the left and right housings are not easily separated from each other, and the housing can have a strong structure.

Preferably, in the embodiment, the top of the housing is provided with an upper outer rotary axial plate 71 circular in shape; the upper outer rotary axial plate 71 cover the top of the rotary sleeve 3, and the surface of the upper side of the upper outer rotary axial plate 71 is provided with a protrusion 71_1 circular in shape. The top of the left housing 2_1 and the top of the right housing 2_2 are respectively provided with a semi-circular slot 92 in shape corresponding to the protrusion 71_1, the semi-circular slot 92 of the left housing 2_1 and the semi-circular slot 91 of the right housing 2_2 can be combined to just catch the protrusion 71_1, whereby the protrusion 71_1 of the upper outer rotary axial plate 71 is rotatably installed on the top of the housing. The top of the upper central shaft 51 is fixed at the bottom of the upper outer rotary axial plate 71, whereby the upper outer rotary axial plate 71 is able to drive the rotary sleeve 3 to rotate via the upper central shaft 51.

The upper outer rotary axial plate 71 is further provided with a fixation element for being fixed on the housing; if necessary, the upper outer rotary axial plate 71 can be firmly fixed at the housing via the fixation element. For example, in the embodiment, the fixation element of the upper outer rotary axial plate 71 is an upper positioning column 93, and the housing and the protrusion 71_1 of the upper outer rotary axial plate 71 are respectively provided with an upper positioning hole 94 in the same line. In the embodiment, the upper portion of the left housing 2_1, the protrusion 71_1 of the upper outer rotary axial plate 71 and the upper portion of the upper outer rotary axial plate 71 and the right housing 2_2 are respectively provided with an upper positioning hole 94. When the upper positioning column 93 penetrates through the upper positioning hole 94, the upper outer rotary axial plate 71 and the housing are firmly fixed with each other because the upper positioning column 93 is fixed at the upper positioning hole 94. On the contrary, when the upper positioning column 93 fails to be inserted into the upper positioning hole 94, the upper outer rotary axial plate 71 can rotate freely.

Therefore, as described above, when the upper positioning column 93 fails to be inserted into the upper positioning hole 94, the upper central shaft 51 can be driven to rotate by rotating the upper outer rotary axial plate 71; then, the upper central shaft 51 can rotate to tighten the upper spiral spring 41 so as to make the rotary sleeve 3 to rotate to reel the flexible printed circuit board 10. On the contrary, when the upper positioning column 93 is inserted into the upper positioning hole 94, and the flexible printed circuit board 10 is pulled out to rotate the rotary sleeve 3, the upper spiral spring gets loose because the upper outer rotary axial plate 71 is fixed. The advantage of the structure is that as the upper outer rotary axial plate 71 has the function to rotate the rotary sleeve 3 from outside, so it is possible to hold the outer surface of the upper outer rotary axial plate 71 to rotate it to tighten the upper spiral spring 41 after all components are assembled; then, the upper positioning column 93 can be inserted in to the upper positioning hole 94 to finish the assembly operation, so the assembly operation is very convenient. On the contrary, when assembling the conventional flat cable reel device, the user should tighten the spiral spring in advance and then install the upper housing and the other components, which is very inconvenient for the user.

Preferably, the protrusion 71_1 of the upper outer rotary axial plate 71 is provided with a fan-shaped slot 71_2. When the upper positioning column 93 fails to be inserted into the upper positioning hole 94, the user can conveniently rotate the upper outer rotary axial plate 71 via the fan-shaped slot 71_2.

Those skilled in the art must understand that the bottom of the housing can also have the same mechanism symmetrical to the above structure according to the above structure and principle for the user to rotate the rotary sleeve 3 from the bottom of the housing. For example, in the embodiment, the bottom of the housing is provided with a lower outer rotary axial plate 72 symmetrical to the upper outer rotary axial plate 71 and a lower positioning column 95 symmetrical to the upper positioning column 93, so the user can rotate the rotary sleeve 3 from the top and the bottom of the housing at the same time, which can provide balanced rotation force. Thus, one end of the housing having the mechanism to rotate the rotary sleeve 3 from outside, and all of both ends of the housing having the mechanism to rotate the rotary sleeve 3 from outside should be in the protection range of the present invention.

Preferably, the top of the upper central shaft 51 can be integrally formed or caught on the housing, and the bottom of the lower central shaft 52 can be integrally formed with or caught on the housing. More specifically, in the embodiment, the top of the upper central shaft 51 can be integrally formed with the lower surface of the upper outer rotary axial plate 71, and the bottom of the lower central shaft 52 can be integrally formed with the upper surface of the lower outer rotary axial plate 72. Of course, the central shaft and the outer rotary axial plate can be manufactured separately; for example, the top of the upper central shaft 51 is caught on the lower surface of the upper outer rotary axial plate 7, and the bottom of the lower central shaft 52 is caught on the upper surface of the lower outer rotary axial plate 72 so as to satisfy the different the material strength requirements of the outer rotary axial plates and the central shafts; once the central shafts connect to the inner center of the spiral spring, the central shafts should resist the tension of the spiral spring stretching or retracting; therefore, the outer rotary axial plates can be made of plastics, but the central shafts can be made of metal bar capable of resisting strong tension and with low diameter.

Preferably, in the embodiment, the bottom of the protection sheet 6 is integrally formed with a lower rotary sleeve cover 82 circular in shape, and the lower rotary sleeve cover 82 is provided with a lower slot 82_1, and the bottom of the rotary sleeve 3 is provided with a lower protrusion edge 33 corresponding to the lower slot 82_1 of the lower rotary sleeve cover 82. When assembling the device, the user inserts the lower protrusion edge 33 of the rotary sleeve 3 into the lower slot 82_1 of the lower rotary sleeve cover 82 whereby the lower rotary sleeve cover 82 is caught on the bottom of the rotary sleeve 3, and the protection sheet 6 is fixed on the rotary sleeve 3. Further, a buckle area 63 is formed between the protection sheet 6 and the rotary sleeve 3. The lower rotary sleeve cover 82 is further provided with a lower circular hole 82_2 for the lower central shaft 52 to penetrate through. The top of the rotary sleeve 3 is caught and fixed on the upper rotary sleeve cover 81, and the upper rotary sleeve cover 81 is provided with an upper slot 81_1, and the top of the rotary sleeve 3 and the top of the protection sheet 6 are respectively provided with an upper protrusion edge 97 corresponding to the upper slot 81_1 of the upper rotary sleeve cover 81. When assembling the device, the user inserts the upper protrusion edge 97 into the upper slot 81_1 of the upper rotary sleeve cover 81. Besides, the external diameter of the upper rotary sleeve cover 81 and the external diameter of the lower rotary sleeve cover 82 are slightly shorter than the inner diameter of the housing. Compared with the conventional flat cable reel device, the advantages of the above structure are: (1) the rotary sleeve 3 and the protection sheet 6 are two independent components, so the protection sheet 6 can be freely removed to make the assembly operation more convenient; further, which can also avoid the problem that the current plastic injection molding cannot increase the mold removing precision when the mold removing space is too deep and too narrow; thus, the above structure can provide more space for the rotary sleeve 3, and can also make the operation of put the flexible printed circuit board 10 on the outer surface of the rotary sleeve 3 easier; (2) the structure has independent rotary sleeve 3 and protection sheet 6, so the function of the rotary sleeve 3 is only to mount the spiral spring; for the reason, the rotary sleeve 3 can be a simple ring structure; thus, the rotary sleeve 3 can become stronger and will not be deformed or damaged because the spiral spring inside the rotary sleeve 3 stretches or retracts.

Preferably, in the embodiment, the center of the rotary sleeve 3 is provided with a penetration hole 34 circular in shape, and the penetration hole 34 interconnects the center of the upper accommodating space 31 to the center of the lower accommodating space 32, whereby the bottom of the upper central shaft 51 is disposed at the top of the penetration hole 34, and the top of the lower central shaft 52 is disposed at the bottom of the penetration hole 34. In addition, the upper central shaft 51 is provided with a clamping groove 98 for catching the inner center of the upper spiral spring 41, and the upper portion of the rotary sleeve 3 is provided with a clamping space 99 for catching the outer side of the upper spiral spring 41; the lower central shaft 52 is provided with a clamping groove 98 for catching the inner center of the lower spiral spring 42, and the lower portion of the rotary sleeve 3 is provided with a clamping space 99 for catching the outer side of the lower spiral spring 42. Of course, the upper central shaft 51 and the lower central shaft 52 are at the same vertical line to form the rotation shaft of the rotary sleeve 3. In this way, the rotary sleeve 3 can stably rotate around the rotation shaft formed by the upper central shaft 51 and the lower central shaft 52.

Preferably, the housing composed of the left housing 2_1 and the right housing 2_2 of the present invention is a sealing-type housing, and the sealing-type housing is a cylinder; thus, the reel device can have a circular and smooth appearance, which is very helpful for the device to smoothly slide inside the narrow and limited space of the housing of a server, and can avoid the device may be influenced by the internal components of the housing of the server when moving forward or backward.

The assembly process of the present invention is: first, put the upper spiral spring 41 into the upper accommodating space 31 of the rotary sleeve 3, and put the lower spiral spring 42 into the lower accommodating space 32 of the rotary sleeve 3, and make the outer side of the upper spiral spring 41 be caught on the clamping space 99 at the upper portion of the rotary sleeve 3, and make the outer side of the lower spiral spring 42 be caught on the clamping space at the lower portion of the rotary sleeve 3; then, put the flexible printed circuit board 10 around the outer surface of the rotary sleeve 3, and then fix the protection sheet 4 to make the flexible printed circuit board 10 be fixed in the buckle area 61 between the protection sheet 6 and the outer surface of the rotary sleeve 3; next, catch the upper rotary sleeve cover 81 on the top of the rotary sleeve 3; then, install the upper outer rotary axial plate 71 and the lower outer rotary axial plate 71, and then make the inner center of the upper spiral spring 41 be caught on the clamping groove 98 of the upper central shaft 51, and make the inner center of the lower spiral spring 42 be caught on the clamping groove 98 of the lower central shaft 52; afterward, combine and catch the left housing 2_1 and the right housing 2_2, and then make one end of the flexible printed circuit board 10 penetrate out of the board outlet 91 of the left housing 2_1, and the other end thereof penetrate out of the board outlet 91 of the right housing 2_2; then, hold the upper surfaces of the upper outer rotary axial plate 71 and the lower outer rotary axial plate 72 at the same time to rotate them to tighten the upper spiral spring 41 and the lower spiral spring 42; finally, insert the upper positioning column 93 into the upper positioning hole 84, and insert the lower positioning column 95 into the lower positioning hole 96 to finish the assembly process.

The working principle of the embodiment is: during the initial status, the flexible printed circuit board 10 is reeled around the rotary sleeve 3; when it is necessary to pull out the flexible printed circuit board 10, the user can pull one end or both ends of the flexible printed circuit board 10 to stretch the flexible printed circuit board 108 and make the flexible printed circuit board 10 being the stretching status; at this time, if the user release the flexible printed circuit board 10 or let it freely move with the rotary sleeve 10, the rotary sleeve 3 rotates by the spring force provided by the upper spiral spring 41 and the lower spiral spring 42, so the flexible printed circuit board 10 can be reeled by the rotary sleeve 3 to return to the initial status; in this way, the flexible printed circuit board 10 can be automatically reeled.

To sum up, the differences between the first embodiment and the second embodiment are: the second embodiment adopts a sealing-type housing structure with the left housing and the right housing without the support columns; in addition, the second embodiment further includes the upper outer rotary axial plate 71 and the lower outer rotary axial plate 72, so the user can hold the rotary sleeve 3 to rotate the rotary sleeve 3. The other structures of the second embodiment are the same with those of the first embodiment.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A flat cable reel device, characterized in comprising a housing, a rotary sleeve, an upper spiral spring and a lower spiral spring, wherein the housing is provided with a board outlet; an upper portion of the rotary sleeve is provided with an upper accommodating space and a lower portion of the rotary sleeve is provided with a lower accommodating space; the upper spiral spring is disposed in the upper accommodating space and the lower spiral spring is disposed at the lower accommodating space; an upper portion of the housing is provided with an upper central shaft and a lower portion of the housing is provided with a lower central shaft; the upper central shaft extends into the upper accommodating space of the rotary sleeve and catches the upper spiral spring; the lower central shaft extends into the lower accommodating space of the rotary sleeve and catches the lower spiral spring, whereby the rotary sleeve is rotatably disposed in the housing, and an outer surface of the rotary sleeve is provided with a protection sheet for catching the flexible printed circuit board.

2. The flat cable reel device of claim 1, characterized in that a top of the upper central shaft is integrally formed with or caught on the housing, and a bottom of the lower central shaft is integrally formed with or caught on the housing.

3. The flat cable reel device of claim 1, characterized in that a bottom of the protection sheet is integrally formed with a lower rotary sleeve cover circular in shape, and the lower rotary sleeve cover is provided with a lower slot, and a bottom of the rotary sleeve is provided with a lower protrusion edge corresponding to the lower slot of the lower rotary sleeve cover, whereby the lower rotary sleeve cover is caught on the bottom of the rotary sleeve, the protection sheet is fixed on the rotary sleeve, and a buckle area is formed between the protection sheet and the rotary sleeve; the lower rotary sleeve cover is further provided with a lower circular hole for the lower central shaft to penetrate through; a top of the rotary sleeve is caught and fixed on the upper rotary sleeve cover, the upper rotary sleeve cover is provided with an upper slot, and the top of the rotary sleeve and a top of the protection sheet are respectively provided with an upper protrusion edge corresponding to the upper slot of the upper rotary sleeve cover.

4. The flat cable reel device of claim 1, characterized in that a center of the rotary sleeve is provided with a penetration hole circular in shape, and the penetration hole interconnects a center of the upper accommodating space to a center of the lower accommodating space, whereby a bottom of the upper central shaft is disposed at a top of the penetration hole, and a top of the lower central shaft is disposed at a bottom of the penetration hole; the upper central shaft is provided with a clamping groove for catching an inner center of the upper spiral spring, and the upper portion of the rotary sleeve is provided with a clamping space for catching an outer side of the upper spiral spring; the lower central shaft is provided with a clamping groove for catching an inner center of the lower spiral spring, and the lower portion of the rotary sleeve is provided with a clamping space for catching an outer side of the lower spiral spring.

5. The flat cable reel device of claim 1, characterized in that the housing comprises an upper housing, a lower housing, and the upper housing is combined with the lower housing to form the housing; the board outlet comprises a left board outlet and a right board outlet, and the rotary sleeve is rotatably disposed between the upper housing and the lower housing.

6. The flat cable reel device of claim 5, characterized in that there are four support columns arranged to form a rectangle, and connecting four corners of the upper housing to four corners of the lower housing; two support columns in left side forms the left board outlet, and two support columns in right side forms the right board outlet; the support column in front of the left board outlet and the support column behind the right board outlet contact the flexible circuit board to serve as force bearing support columns to bear a force generated during the flexible circuit board is unreeled; the left board outlet is in the vicinity of a front end of a horizontal central axis of the rotary sleeve, and the right board outlet is in the vicinity of a rear end of the horizontal central axis of the rotary sleeve; the support column in front of the left board outlet and the support column behind the right board outlet are metal support columns, and one end of each of the metal support columns is caught on the upper housing and the other end thereof is caught on the lower housing.

7. The flat cable reel device of claim 1, characterized in that the housing comprises a left housing and a right housing, and the left housing and the right housing are caught with each other to form the housing; the board outlet include a left board outlet and a right board outlet; the left board outlet is disposed on the left housing, and the right board outlet is disposed on the right housing; the rotary sleeve rotatably disposed between the left housing and the right housing.

8. The flat cable reel device of claim 7, characterized in that a top of the housing is provided with an upper outer rotary axial plate circular in shape; the upper outer rotary axial plate covers the top of the rotary sleeve, and a surface of an upper side of the upper outer rotary axial plate is provided with a protrusion circular in shape; a top of the left housing and a top of the right housing are respectively provided with a slot semi-circular in shape corresponding to the protrusion, whereby the protrusion of the upper outer rotary axial plate is rotatably installed on the top of the housing; a top of the upper central shaft is fixed at a bottom of the upper outer rotary axial plate whereby the upper outer rotary axial plate is able to drive the rotary sleeve to rotate via the upper central shaft; the upper outer rotary axial plate is further provided with a fixation element for being fixed on the housing; the fixation element of the upper outer rotary axial plate is an upper positioning column, and the housing and the protrusion of the upper outer rotary axial plate are respectively provided with an upper positioning hole in the same line, whereby when the upper positioning column penetrates through the upper positioning holes, the upper outer rotary axial plate and the housing are fixed by and connected to each other.

9. The flat cable reel device of claim 2, characterized in that the housing comprises an upper housing, a lower housing, and the upper housing is combined with the lower housing to form the housing; the board outlet comprises a left board outlet and a right board outlet, and the rotary sleeve is rotatably disposed between the upper housing and the lower housing.

10. The flat cable reel device of claim 9, characterized in that there are four support columns arranged to form a rectangle, and connecting four corners of the upper housing to four corners of the lower housing; two support columns in left side forms the left board outlet, and two support columns in right side forms the right board outlet; the support column in front of the left board outlet and the support column behind the right board outlet contact the flexible circuit board to serve as force bearing support columns to bear a force generated during the flexible circuit board is unreeled; the left board outlet is in the vicinity of a front end of a horizontal central axis of the rotary sleeve, and the right board outlet is in the vicinity of a rear end of the horizontal central axis of the rotary sleeve; the support column in front of the left board outlet and the support column behind the right board outlet are metal support columns, and one end of each of the metal support columns is caught on the upper housing and the other end thereof is caught on the lower housing.

11. The flat cable real device of claim 3, characterized in that the housing comprises an upper housing, a lower housing, and the upper housing is combined with the lower housing to form the housing; the board outlet comprises a left board outlet and a right board outlet, and the rotary sleeve is rotatably disposed between the upper housing and the lower housing.

12. The flat cable real device of claim 11, characterized in that there are four support columns arranged to form a rectangle, and connecting four corners of the upper housing to four corners of the lower housing; two support columns in left side forms the left board outlet, and two support columns in right side forms the right board outlet; the support column in front of the left board outlet and the support column behind the right board outlet contact the flexible circuit board to serve as force bearing support columns to bear a force generated during the flexible circuit board is unreeled; the left board outlet is in the vicinity of a front end of a horizontal central axis of the rotary sleeve, and the right board outlet is in the vicinity of a rear end of the horizontal central axis of the rotary sleeve; the support column in front of the left board outlet and the support column behind the right board outlet are metal support columns, and one end of each of the metal support columns is caught on the upper housing and the other end thereof is caught on the lower housing.

13. The flat cable real device of claim 4, characterized in that the housing comprises an upper housing, a lower housing, and the upper housing is combined with the lower housing to form the housing; the board outlet comprises a left board outlet and a right board outlet, and the rotary sleeve is rotatably disposed between the upper housing and the lower housing.

14. The flat cable real device of claim 13, characterized in that there are four support columns arranged to form a rectangle, and connecting four corners of the upper housing to four corners of the lower housing; two support columns in left side forms the left board outlet, and two support columns in right side forms the right board outlet; the support column in front of the left board outlet and the support column behind the right board outlet contact the flexible circuit board to serve as force bearing support columns to bear a force generated during the flexible circuit board is unreeled; the left board outlet is in the vicinity of a front end of a horizontal central axis of the rotary sleeve, and the right board outlet is in the vicinity of a rear end of the horizontal central axis of the rotary sleeve; the support column in front of the left board outlet and the support column behind the right board outlet are metal support columns, and one end of each of the metal support columns is caught on the upper housing and the other end thereof is caught on the lower housing.

15. The flat cable real device of claim 2, characterized in that the housing comprises a left housing and a right housing, and the left housing and the right housing are caught with each other to form the housing; the board outlet include a left board outlet and a right board outlet; the left board outlet is disposed on the left housing, and the right board outlet is disposed on the right housing; the rotary sleeve rotatably disposed between the left housing and the right housing.

16. The flat cable real device of claim 15, characterized in that a top of the housing is provided with an upper outer rotary axial plate circular in shape; the upper outer rotary axial plate covers the top of the rotary sleeve, and a surface of an upper side of the upper outer rotary axial plate is provided with a protrusion circular in shape; a top of the left housing and a top of the right housing are respectively provided with a slot semi-circular in shape corresponding to the protrusion, whereby the protrusion of the upper outer rotary axial plate is rotatably installed on the top of the housing; the top of the upper central shaft is fixed at a bottom of the upper outer rotary axial plate whereby the upper outer rotary axial plate is able to drive the rotary sleeve to rotate via the upper central shaft; the upper outer rotary axial plate is further provided with a fixation element for being fixed on the housing; the fixation element of the upper outer rotary axial plate is an upper positioning column, and the housing and the protrusion of the upper outer rotary axial plate are respectively provided with an upper positioning hole in the same line, whereby when the upper positioning column penetrates through the upper positioning holes, the upper outer rotary axial plate and the housing are fixed by and connected to each other.

17. The flat cable real device of claim 3, characterized in that the housing comprises a left housing and a right housing, and the left housing and the right housing are caught with each other to form the housing; the board outlet include a left board outlet and a right board outlet; the left board outlet is disposed on the left housing, and the right board outlet is disposed on the right housing; the rotary sleeve rotatably disposed between the left housing and the right housing.

18. The flat cable real device of claim 17, characterized in that a top of the housing is provided with an upper outer rotary axial plate circular in shape; the upper outer rotary axial plate covers the top of the rotary sleeve, and a surface of an upper side of the upper outer rotary axial plate is provided with a protrusion circular in shape; a top of the left housing and a top of the right housing are respectively provided with a slot semi-circular in shape corresponding to the protrusion, whereby the protrusion of the upper outer rotary axial plate is rotatably installed on the top of the housing; a top of the upper central shaft is fixed at a bottom of the upper outer rotary axial plate whereby the upper outer rotary axial plate is able to drive the rotary sleeve to rotate via the upper central shaft; the upper outer rotary axial plate is further provided with a fixation element for being fixed on the housing; the fixation element of the upper outer rotary axial plate is an upper positioning column, and the housing and the protrusion of the upper outer rotary axial plate are respectively provided with an upper positioning hole in the same line, whereby when the upper positioning column penetrates through the upper positioning holes, the upper outer rotary axial plate and the housing are fixed by and connected to each other.

19. The flat cable real device of claim 4, characterized in that the housing comprises a left housing and a right housing, and the left housing and the right housing are caught with each other to form the housing; the board outlet include a left board outlet and a right board outlet; the left board outlet is disposed on the left housing, and the right board outlet is disposed on the right housing; the rotary sleeve rotatably disposed between the left housing and the right housing.

20. The flat cable real device of claim 19, characterized in that a top of the housing is provided with an upper outer rotary axial plate circular in shape; the upper outer rotary axial plate covers the top of the rotary sleeve, and a surface of an upper side of the upper outer rotary axial plate is provided with a protrusion circular in shape; a top of the left housing and a top of the right housing are respectively provided with a slot semi-circular in shape corresponding to the protrusion, whereby the protrusion of the upper outer rotary axial plate is rotatably installed on the top of the housing; a top of the upper central shaft is fixed at a bottom of the upper outer rotary axial plate whereby the upper outer rotary axial plate is able to drive the rotary sleeve to rotate via the upper central shaft; the upper outer rotary axial plate is further provided with a fixation element for being fixed on the housing; the fixation element of the upper outer rotary axial plate is an upper positioning column, and the housing and the protrusion of the upper outer rotary axial plate are respectively provided with an upper positioning hole in the same line, whereby when the upper positioning column penetrates through the upper positioning holes, the upper outer rotary axial plate and the housing are fixed by and connected to each other.
